(19) United States
(12) Patent Application Publication
(10) Pub. No.: US 2008/0278849 A1
(43) Pub. Date: Nov. 13, 2008

(54) Flow balancer for track misregistration improvement

(75) Inventors: Haesung Kwon, San Jose, CA (US); Yun-Sik Han, San Jose, CA (US); Yanning Liu, San Ramon, CA (US); Sean Kang, San Jose, CA (US); Hyung Jai Lee, Cupertino, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/800,864

(22) Filed: May 7, 2007

(51) Int. Cl. G11B 33/14

(52) U.S. Cl. 360/97.02

(57) ABSTRACT

Disclosed is a hard disk drive that includes at least one disk enclosed by a cover and a disk. A damper is separated from the disk by an air gap about 1.0 mm. The damper and air gap reduce the velocity of the air flow and any vibration associated with the flow of air.

### BACKGROUND OF THE INVENTION

1. Field of the Invention

The present invention relates to a damper structure that damps vibration within a hard disk drive.

2. Background Information

Hard disk drives contain a plurality of magnetic heads that are coupled to rotating disks. The heads can magnetize and sense the magnetic fields of the disk to write and read data, respectively. The heads are coupled to a pivoting actuator arm that has a voice coil motor.

Data is stored on concentric tracks across the surfaces of the drive. The voice coil motor can move the heads to different tracks. Each track typically contains servo information that is read and used by a servo routine of the drive to maintain the heads on the centers of the tracks.

The disks are rotated by a spindle motor. The rotation of the disks creates a flow of air within the disk drive. The flow of air cooperates with air bearing surfaces of the heads to create air bearings. The air bearings prevent or minimize contact and corresponding wear between the heads and the surfaces of the disks.

The flow of air can create vibration within the drive. Vibration can caused unwanted movement of the heads. The vibration must either be attenuated, or compensated for by the servo of the disk drive. The vibration can be attenuated with dampers placed within the drive. For example, a viscoelastic damping material can be integrated into the drive housing, spindle motor assembly, etc. Additionally, the servo can incorporate filters to filter out low frequency vibrations.

To increase disk drive capacity it is desirable to increase the track per inch (“TPI”) density of the disks. TPI is dependent on track mis-registration (“TMR”) which is dependent on vibration among other factors. It would be desirable to provide a damper structure that can reduce the amount of vibration to allow for greater TPI and resultant capacity of a hard disk drive.

### BRIEF SUMMARY OF THE INVENTION

A hard disk drive with a disk that is enclosed by a cover and a base plate. The disk drive has a damper that is attached to said cover and separated from said disk by an air gap about 1.0 mm.

### BRIEF DESCRIPTION OF THE DRAWINGS

FIG. 1 is a top view of an embodiment of a hard disk drive;

FIG. 2 is a cross-sectional view of the hard disk drive;

FIG. 3A-B are graphs showing position error data as a function of the width of an air gap between a damper of the disk drive and a top surface of a disk;

FIG. 4 is a perspective view of a damper plate.

### DETAILED DESCRIPTION

Disclosed is a hard disk drive that includes at least one disk enclosed by a cover and a disk. A damper is separated from the disk by an air gap about 1.0 mm. The damper and air gap reduce the velocity of the air flow and any vibration associated with the flow of air.

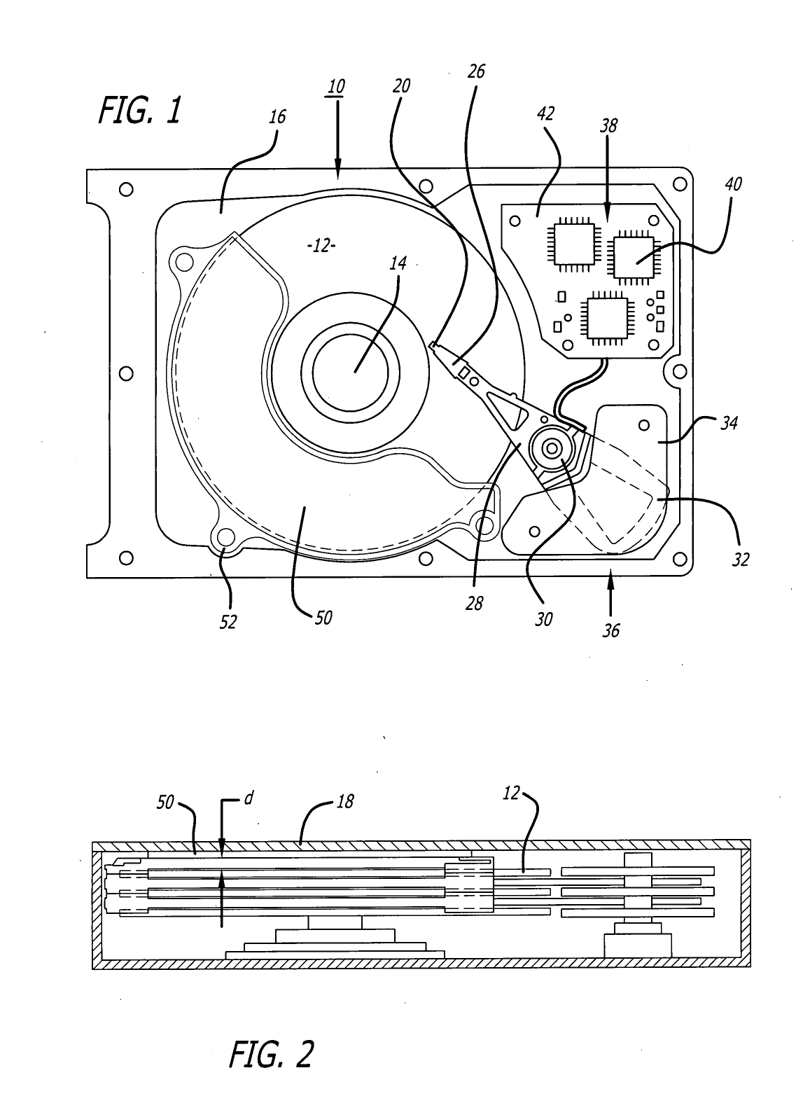

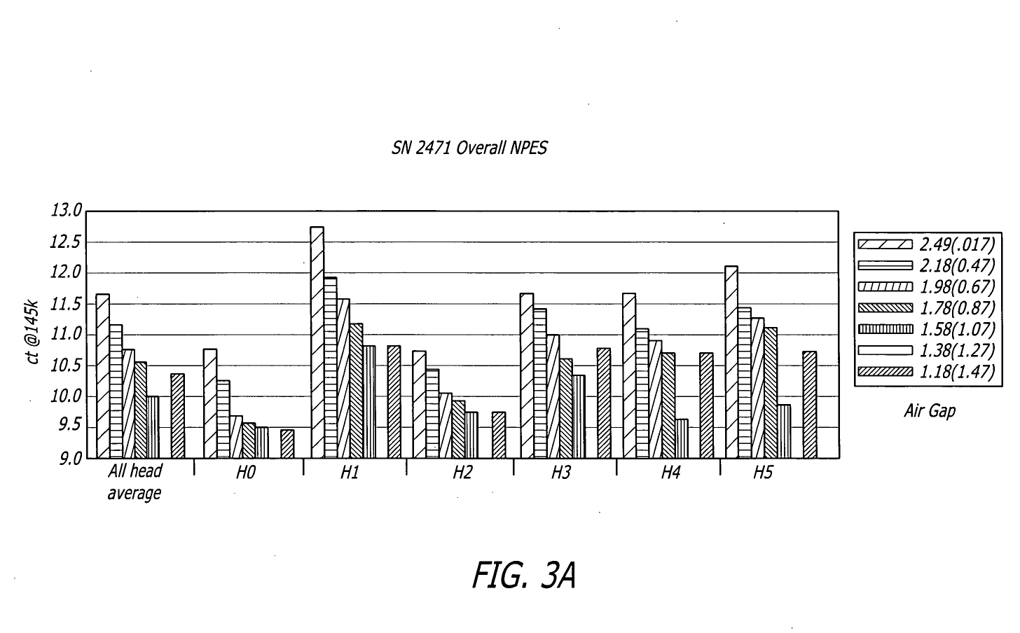

Referring to the drawings more particularly by reference numbers, FIGS. 1 and 2 show an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

During operation of the disk drive 10 the spindle motor 14 rotates the disks 12. The rotation of the disks 12 creates a flow of air within the drive.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

The drive 10 includes a damper 50 that is located adjacent to the disk 12. The damper 50 is preferably shaped and located within the disk drive 10 so as to not interfere with movement of the actuator arm 28.

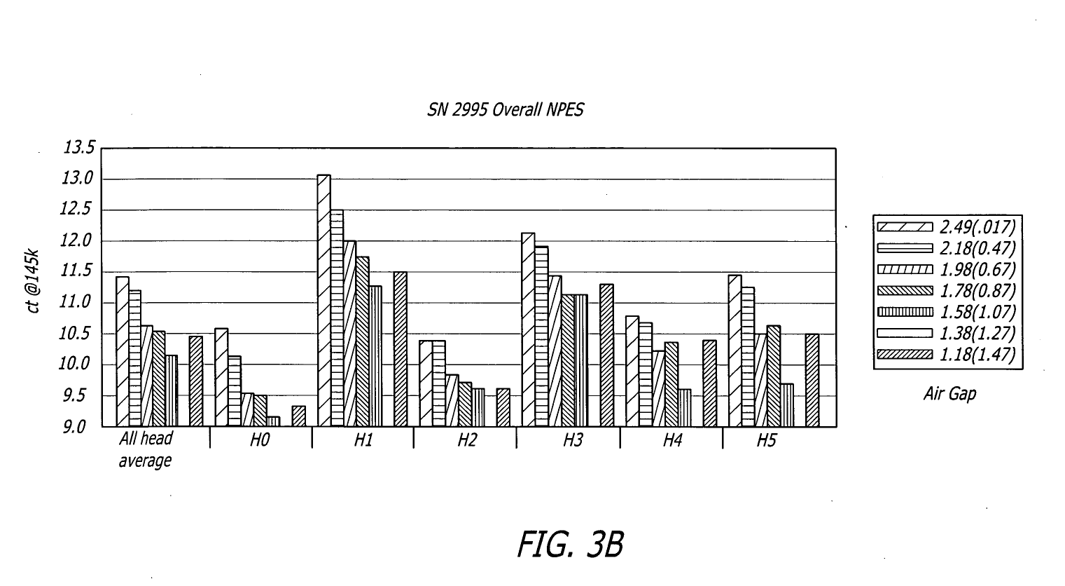

The damper 50 is located a specified distance from a disk surface to reduce the velocity of the air flow within the drive. Vibration caused by the flow of air is proportional to the velocity of the air. Reducing the velocity of the air produces a corresponding reduction in vibration within the disk drive. The distance between the damper 50 and disk surface should be about 1.0 millimeters. As shown by FIGS. 3A and 3B, there is a significant reduction in the position error signal (“PES”) of a drive when the air gap between the bottom of the damper 50 and the top surface of the top disk is about 1.0 mm. This reduction in PES is a function of reduced vibration in the drive.

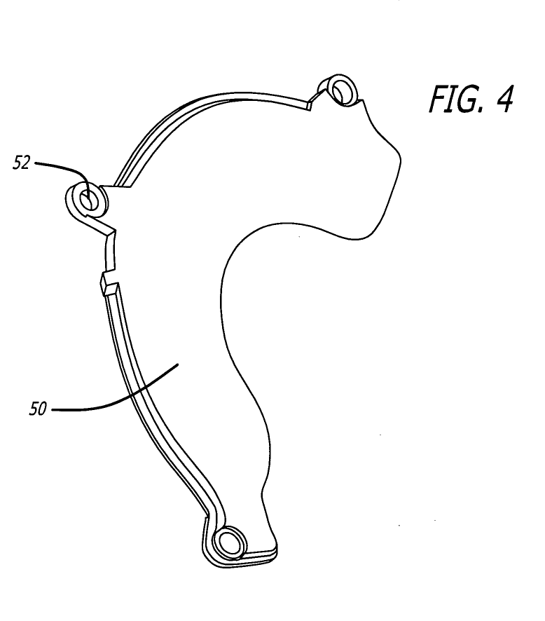

FIG. 4 shows an example of a damper 50. The damper 50 can be a plate with thru holes 52 that allow for attachment to the cover 18 of the drive. The damper plate 52 is preferably constructed from a plastic material, but may be made from other materials. To minimize the impact on the disk drive profile the damper plate 52 can be attached to an embossed area of the cover without using fasteners. The damper plate 52 and embossed cover can have matching ridges and grooves that attach the two components.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a base plate;
a disk;
a spindle motor that is mounted to said base plate;
a head coupled to said disk;
an actuator arm coupled to said head;
a voice coil motor coupled to said actuator arm;
a cover that is attached to said base plate and encloses said disk, said spindle motor, said head and said actuator arm; and,
a damper that is attached to said cover and separated from said disk by an air gap about 1.0 mm.

2. The disk drive of claim 1, wherein said damper includes a plate attached to said cover.

3. The disk drive of claim 1, wherein said damper is a plate constructed from a plastic material.

4. The disk drive of claim 1, wherein said damper is attached to an embossed area of said cover.

5. A hard disk drive, comprising:
a base plate;
a disk;
a spindle motor that is mounted to said base plate;
a head coupled to said disk;
an actuator arm coupled to said head;
a voice coil motor coupled to said actuator arm;
a cover that is attached to said base plate and encloses said disk, said spindle motor, said head and said actuator arm; and,
damper means for reducing a vibration in the hard disk drive.

6. The disk drive of claim 5, wherein said damper means includes a plate attached to said cover.

7. The disk drive of claim 5, wherein said damper includes a plate,constructed from a plastic material.

8. The disk drive of claim 5, wherein said damper means is attached to an embossed area of said cover.

9. A method for reducing a vibration caused by air flow within a hard disk drive, comprising:
providing a damper separated from a disk by an air gap about 1.0 mm;
rotating a disk to create a flow of air and a vibration; and, damping the vibration with the air gap.
